(19) United States
(12) Patent Application Publication
(10) Pub. No.: US 2021/0406803 A1
(43) Pub. Date: Dec. 30, 2021

(54) SYSTEMS AND METHODS FOR DETERMINING SERVICE QUALITY

(71) Applicant: Thomson Reuters Enterprise Centre GmbH, Zug (CH)

(72) Inventor: Michael J. Krause, Farmington, MN (US)

(21) Appl. No.: 17/356,438

(22) Filed: Jun. 23, 2021

Related U.S. Application Data
(60) Provisional application No. 63/043,273, filed on Jun. 24, 2020.

(51) Int. Cl. G06Q 10/06; G06Q 10/10; G06F 16/22

(52) U.S. Cl. CPC G06Q 10/06393; G06Q 10/06395; G06F 16/2237; G06Q 10/10

(57) ABSTRACT

Methods and systems for providing mechanisms for evaluating quality of inter-related services provided to a system are provided. In embodiments, measurements associated with various metrics of the services are performed. The measurements are then applied to various scoring models to obtain service scores. In embodiments, the various scoring models score the measurements against expected performance. The service scores are aggregated to obtain an overall service score that represents performance of the service over a defined period of time. In this manner, the techniques disclosed herein provide for a scalable, repeatable, and systematic way to evaluate and score the quality of services across multiple providers within an enterprise system.

### CROSS-REFERENCE TO RELATED APPLICATION

The present application claims the benefit of U.S. Provisional Application No. 63/043,273 filed Jun. 24, 2020 and entitled “SYSTEMS AND METHODS OF DETERMINING SERVICE QUALITY,” the disclosure of which is incorporated by reference herein in its entirety.

### TECHNICAL FIELD

The present invention relates generally to service quality evaluation, and more particularly to a system for determining the quality of a service provided within a system based on an overall service score.

### BACKGROUND OF THE INVENTION

Current enterprise systems rely on many and various applications and/or services (often referred to herein as simply “services”) to provide functionality to users. These services may be provided by multiple service providers, who may host (and in some cases manage) the underlying resources to provide the services to the enterprise systems. In most cases, the various services provided by the various providers may depend on each other. For example, a billing generation application may operate to generate bills but may depend on a time tracking application to obtain timecard data in order to generate the bill. In another example, a research application (e.g., an application having an external interface that a customer may use for research purposes) may depend on content-providing services within the system. Because of the inter-dependence of the various systems, an event associated with one service may impact the performance of other services, or even the enterprise system as a whole. For example, where a content provider experiences a problem (e.g., outage), this may impact the entire enterprise system as most users (including internal and external customers) may be affected. In another example, large usage of a particular service may impact other services, as for example the other services may find themselves overtaxed because of the large usage.

There is currently no effective mechanism for measuring performance of a service provider (e.g., with respect to a particular service provided to the enterprise system) against a target user experience in a repeatable and systematic manner. Furthermore, tracking and/or measuring a service provider's progress (e.g., with respect to a target experience) may be difficult in current systems, as this may require a repeatable and systematic entry point.

In a particular example, current enterprise case management systems operate to track events (or cases) associated with services provided by various service providers. These events may include incidents, problems, and other related information (e.g., configurations, changes, etc.) that may affect the various services. In some cases, the events are minor events (e.g., an event affecting a single user of the service or the system using the service), or major incidents (e.g., an incident impacting other services and/or a large number of users). To track these events, the various service providers may implement case management systems. In large enterprise systems, tracking the various events may involve a large volume of inter-related content, as many services within the enterprise systems are inter-dependent. Even more, the amount of inter-related content and cases increase when more than one case management system is involved across multiple service providers within an enterprise system. Moreover, the various case management systems may operate differently and may implement the same case tracking functionality using different approaches. As such, managing the different service providers within an enterprise system, such as evaluating performance of services and/or service providers, may require different approaches based on the individual implementations of the service providers. This may require implementing multiple systems, protocols, and/or systems with different approaches to assess and evaluate the performance and/or the performance impact of the various service providers.

### BRIEF SUMMARY OF THE INVENTION

Aspects of the present disclosure provide systems, methods, and computer-readable storage media that support mechanisms for evaluating and scoring a quality of service (QoS) for services provided to a system from service providers to improve the services across the system. In some embodiments, multiple service providers may provide services and/or applications for various and/or different platforms within a system or deployment (e.g., within an enterprise system). The multiple services provided by the multiple providers may be inter-dependent. Aspects of the present disclosure provide mechanisms for evaluating and reporting performance of various aspects of the service on a time-based scale, and identifying deficiencies within the different services (such as with respect to user experience, the overall system, and/or with respect to other services). Service performance may be evaluated by comparing conformance of the various aspects of the services to expected performance, tracking the performance against a target experience over time, and scoring the services based, at least in part, on the measurements. For example, in some embodiments, the services may be evaluated by collecting information associated with cases or events. A case or event may refer to an event associated with a service that may have an impact on performance (e.g., an impact on a user experience). In aspects, individual cases may be scored, and individual scores may be aggregated to measure performance on a time-based scale. In some embodiments, the scoring formulas may apply to various enterprise functions related to the individual services. In one particular embodiment, an overall service score may be obtained for a service, and the overall service score may be used to track and manage service performance at different levels within an enterprise system and with respect to other service providers. In this manner, the techniques disclosed herein provide for a scalable, repeatable, and systematic way to evaluate and score QoS across multiple providers within an enterprise system.

In one particular embodiment, a method of evaluating performance of a service may be provided. The method may include receiving information related to a plurality of events associated with one or more services deployed within a system, the one or more services related to each other, obtaining, based on the received information, measurements associated with one or more metrics categories for at least one service of the one or more services, applying the obtained measurements to a plurality of score models to obtain a plurality of individual service scores, each individual service score of the plurality of individual service scores corresponding to a different score model, combining at least a portion of the plurality of individual service scores to generate an overall service score, and generating at least one service performance report for the at least one service.

In another embodiment, a system for evaluating performance of a service may be provided. The system may include an enterprise system including one or more services deployed therein, the one or more services related to each other. The system may also include a server configured to perform operations including receiving information related to a plurality of events associated with one or more services deployed within a system, the one or more services related to each other, obtaining, based on the received information, measurements associated with one or more metrics categories for at least one service of the one or more services, applying the obtained measurements to a plurality of score models to obtain a plurality of individual service scores, each individual service score of the plurality of individual service scores corresponding to a different score model, combining at least a portion of the plurality of individual service scores to generate an overall service score, and generating at least one service performance report for the at least one service.

In yet another embodiment, a computer-based tool for evaluating performance of a service may be provided. The computer-based tool may include non-transitory computer readable media having stored thereon computer code which, when executed by a processor, causes a computing device to perform operations that may include receiving information related to a plurality of events associated with one or more services deployed within a system, the one or more services related to each other, obtaining, based on the received information, measurements associated with one or more metrics categories for at least one service of the one or more services, applying the obtained measurements to a plurality of score models to obtain a plurality of individual service scores, each individual service score of the plurality of individual service scores corresponding to a different score model, combining at least a portion of the plurality of individual service scores to generate an overall service score, and generating at least one service performance report for the at least one service.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a block diagram of an exemplary system configured with capabilities and functionality for providing mechanisms for evaluating and scoring services provided to a system from service providers to improve the services across the system in accordance with embodiments of the present disclosure.

FIG. 2A is a diagram illustrating an example of a mean-time score matrix in accordance with aspects of the present disclosure.

FIG. 2B is a diagram illustrating an example of a customer experience score matrix in accordance with aspects of the present disclosure.

FIG. 2C is a diagram illustrating an example of an overall service score matrix in accordance with aspects of the present disclosure.

FIG. 3A is a diagram illustrating an example of a performance report for a specific service including reports of overall service scores based on a combination of an overall mean-time score and a customer experience score for defined periods of time in accordance with aspects of the present disclosure.

FIG. 3B shows an example of a customer experience scores report, in the form of color coded scores, for various months and includes a number of major events for each month in accordance with aspects of the present disclosure.

FIG. 3C shows example customer experience scores, in the form of color coded scores, for various quarters and includes a number of major events for each quarter in accordance with aspects of the present disclosure.

FIG. 3D shows an example customer experience scores report, in the form of color coded scores, for a year and includes a number of major events for the year in accordance with aspects of the present disclosure.

FIG. 3E shows an example mean-time scores report, in the form of color coded scores, for multiple services deployed within an enterprise system in accordance with aspects of the present disclosure.

FIG. 3F shows a diagram illustrating an example of a mean-time scores report for a service over multiple defined periods of time in accordance with aspects of the present disclosure.

FIG. 4 shows a functional block diagram illustrating an example flow executed to implement aspects of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE INVENTION

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

As noted above, the present disclosure provides mechanisms for evaluating and scoring over time a QoS of services provided to a system from service providers to improve the services across the system. In particular, in some embodiments, performance of various aspects associated with a service provided by a service providers may be evaluated against expected performance metrics to identify deficiencies. For example, service performance may be measured by scoring the service and tracking the performance scores over time. In this manner, the techniques disclosed herein provide for a scalable, repeatable, and systematic way to evaluate and score the quality of service across multiple providers.

As also noted above, as used herein, a case or event may refer to a unit of measure to be used for measuring service performance. A case or event may be associated with various aspects or functions related to the various services. For example, in some aspects, a case may be associated with an event that may impact some aspects of a user experience. For example, an outage associated with a service may have an impact on a user experience, as a user (e.g., an external customer or an internal customer) may not be able to access some functionality of the system (e.g., a functionality associated with the service associated with the outage, or functionality associated with another service that is dependent on the service associated with the outage). In another example, large usage of an application may have an impact on other services, as the other services may be taxed heavily due to the large usage of the application. In some aspects, cases may share common information with other cases. Scoring formulas may applied to individual cases or events, and the scores may be aggregated and computed across multiple cases to measure performance associated with the services on a time-based scale. In some embodiments, the scores of the cases or events may be filtered via the common information.

As used herein, an enterprise system may refer to any of multiple variants of enterprise and end-user systems, either small or large. For example, an enterprise system may include any of many systems including a wide variety and range of systems spanning one or more applications and services. As such, enterprise system, as used herein, includes a broad range of systems that include a broad range of services, and applications.

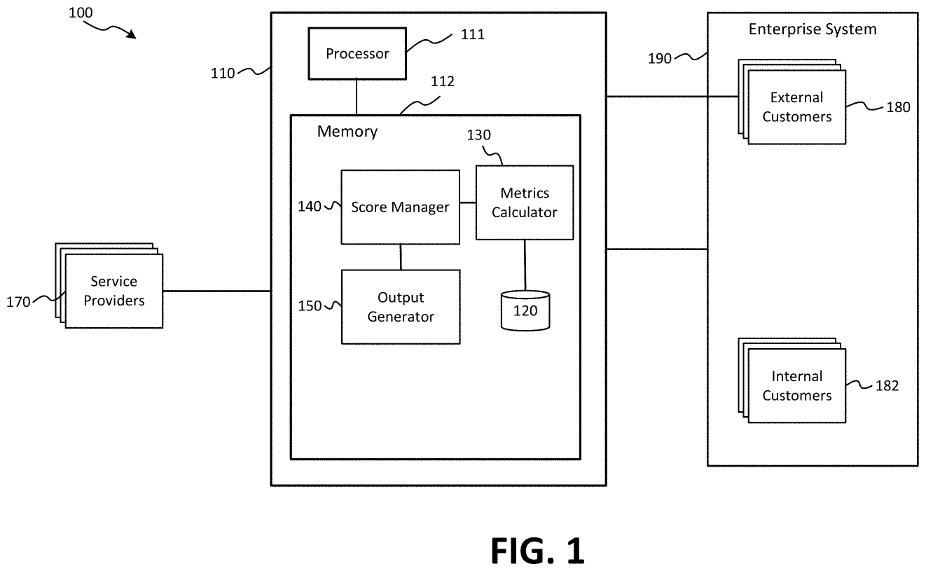

FIG. 1 is a block diagram of an exemplary system 100 configured with capabilities and functionality for providing mechanisms for evaluating and scoring, over time, a QoS of services provided to a system from service providers to improve the services across the system in accordance with embodiments of the present disclosure. As shown in FIG. 1, system 100 includes server 110 configured to include various components for providing various aspects of the functionality described herein. In aspects, server 110 may be a server deployed to provide service performance management and evaluation functionality to evaluate, assess, and/or score service performance of various services deployed within enterprise system 190 in accordance with embodiments of the present disclosure. System 100 may also include service providers 170, which may include one or more service providers that may host, manage, and/or otherwise provide services and/or applications that enterprise system 190 may use to provide functionality to users. In aspects, users of enterprise system 190 may include external customers 180 and internal customers 182. These components, and their individual components, may cooperatively operate to provide functionality in accordance with the discussion herein. For example, in operation according to embodiments, service providers 170 may provide services to be accessed by external customers 180 and/or internal customers 182. The various components of server 110 may cooperatively operate to evaluate and score the quality of the services provided by service providers 170 by measuring conformance of various aspects of the services to target expectations based on various metrics to determine performance, and tracking performance against a target experience to identify performance trends. In aspects, the measurements may be used to determine an overall service score for the various services.

It is noted that the functional blocks, and components thereof, of system 100 of embodiments of the present invention may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally or alternatively, when implemented in software, one or more of the functional blocks, or some portion thereof, may comprise code segments operable upon a processor to provide logic for performing the functions described herein.

Enterprise system 190 may include an enterprise system in which various services and/or applications may be deployed, leveraged, and or relied upon to provide functionality to perform operations by users of an organization. In aspects, enterprise system 190 may represent the technical infrastructure (e.g., software and/or hardware infrastructures) that enables an organization to perform operations. Enterprise systems may typically deploy services and/or applications to implement various functionalities. In aspects, some of the services and/or applications deployed within enterprise system 190 may be managed services, rather than local services. These managed services may be provided by service providers (e.g., service providers 170).

In aspects, users of enterprise system 190 may include external customers 180 and/or internal customers 182. External customers 180 may include customers which are external to enterprise system 190, and functionality provided to external customers 180 may be said to be external-facing. Internal customers 182 may include customers which are internal to enterprise system 190, and functionality provided to internal customers 182 may be said to be internal-facing. In some aspects, internal customers 182 may include employees of the organization. In some cases, events associate with a service may impact external customers 180 and/or internal customers 182.

Service providers 170 may include one or more providers that provide services to enterprise system 190. In aspects, these service providers may include providers that are external to enterprise system 190 (e.g., external vendors) and/or providers internal to enterprise system 190. In some aspects, service providers 170 may include a plurality of different service providers. The services provided by service providers 170 may be inter-dependent. In these cases, the various services from the different providers may share information between each other. For example, a first service may depend on information and/or functionality from a second service. In this case, the second service may provide the information and/or functionality to the first service. As will be appreciated, if the second service fails, there may be an impact on the functionality of the first service, as the first service depends on the second service.

As noted above, in typical systems, service providers 170 may be associated with different case management systems. These case management systems may be used to track cases associated with services provided by the different service providers. The tracked cases, which may include incidents, problems, configuration changes, and/or other events that may have an impact on a user experience (e.g., may affect operations and/or functionality of enterprise system 190), may be used to obtain a limited view of the service performance, as it may be possible to glean a volume of logged cases. However, as noted above, the fact that there are different case management systems used by the different service providers makes it very difficult to evaluate and assess the quality of the services provided by the different service providers, as individual approaches would be needed to assess and evaluate the service providers based on the different case management systems. As will be discussed below, aspects of the present disclosure provide mechanisms for a scalable, repeatable, and systematic way to evaluate and score the quality of service across multiple providers by measuring conformance to expectations and tracking performance against a target experience over time.

Server 110 may be configured to obtain metrics for cases or events associated with at least one service provided by a service provider, to score the cases or events individually based on scoring models, to aggregate the individual scores, and to generate an overall service score to measure service performance on a time-based scale. In aspects, the service performance measured on a time-based scale may be used to determine service performance trends and to identify service improvement opportunities. This functionality of server 110 may be provided by the cooperative operation of various components of server 110, as will be described in more detail below. Although FIG. 1 shows a single server 110, it will be appreciated that server 110 and its individual functional blocks may be implemented as a single device or may be distributed over multiple devices having their own processing resources, whose aggregate functionality may be configured to perform operations in accordance with the present disclosure. Furthermore, those of skill in the art would recognize that although FIG. 1 illustrates components of server 110 as single and separate blocks, each of the various components of server 110 may be a single component (e.g., a single application, server module, etc.), may be functional components of a same component, or the functionality may be distributed over multiple devices/components. In such aspects, the functionality of each respective component may be aggregated from the functionality of multiple modules residing in a single, or in multiple devices.

As shown in FIG. 1, server 110 includes processor 111, memory 112, database 120, metrics calculator 130, score manager 140, and output generator 150. Processor 111 may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some aspects, as noted above, implementations of processor 111 may comprise code segments (e.g., software, firmware, and/or hardware logic) executable in hardware, such as a processor, to perform the tasks and functions described herein. In yet other aspects, processor 111 may be implemented as a combination of hardware and software. Processor 111 may be communicatively coupled to memory 112.

Memory 112 may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. Memory 112 may comprise a processor readable medium configured to store one or more instruction sets (e.g., software, firmware, etc.) which, when executed by a processor (e.g., one or more processors of processor 111), perform tasks and functions as described herein.

Memory 112 may also be configured to facilitate storage operations. For example, memory 112 may comprise database 120 for storing various information related to operations of system 100. For example, database 120 may store scoring formulas and/or models that may be used to score cases, report templates for generating and/or reporting service performance scores, user profiles for accessing information and/or service reports, etc., which system 100 may use to provide the features discussed herein. In aspects, database 120 may include historical data that may include information on various metrics associated with different focus areas for the various services. Database 120 is illustrated as integrated into memory 112, but may be provided as a separate storage module. Additionally or alternatively, database 120 may be a single database, or may be a distributed database implemented over a plurality of database modules.

Metrics calculator 130 may be configured to calculate, measure, and/or otherwise obtain measurements for metrics associated with cases or events that are associated with services provided from service providers. For example, metrics calculator 130 may obtain measurements for any number of metrics associated with different focus areas for measuring and tracking performance of the services. In aspects, the measurements for metrics associated with different focus areas for measuring and tracking performance of the services may be stored in database 120 (or another database). In aspects, obtaining the measurements for the various metrics may include obtaining event information associated with the various services for which measurements are being obtained. In some embodiments, the focus area associated with the metrics obtained for the various services may include development, operations, financial management, security management, and/or customer experience.

For example, in the area of development, metrics calculator 130 may be configured to obtain measurements for metrics associated with application lifecycle, including metrics such as application change rate, and application change currency. In embodiments, application change rate may indicate and/or measure a frequency of software changes, and may be measured based on application change notifications. In aspects, application change currency may include measurements of the number of days, hours, minutes, etc., since a last reported change of the application. In aspects, these application lifecycle metrics may be evaluated to obtain scores that may be used to determine and track a rate of change in the application ecosystem of the enterprise system 190.

In aspects, in the area of development, metrics calculator 130 may be configured to obtain measurements for metrics associated with application usage, including metrics such as usage patterns, usage volume, concurrency of sessions and/or transactions, etc. In aspects, these metrics may be evaluated to obtain scores that may be used to determine and track usage patterns of applications of the enterprise system 190. As noted above, the usage pattern of an application may be used to determine a service score for the application (and/or associated service).

In aspects, in the area of financial management, metrics calculator 130 may be configured to obtain measurements for metrics associated with service financial performance. In aspects, service financial performance metrics may include metrics that may indicate the impact of a service on the financial performance of enterprise system 190. For example, financial performance metrics may include metrics associated with financial management and cost optimization. In aspects, financial management and cost optimization may include the ability to operate optimally and maintain costs at scale. Dynamic provisioning of applications and infrastructure may contribute to overall costs. In aspects, financial performance metrics may include metrics that are measured against specific business requirements and observation of run rates. For example, cost optimization measurements may indicate the amount of investment (e.g., in US dollars) for a key service. A cost per transaction may be obtained based on associated usage patterns of the service.

In aspects, in the area of security management, metrics calculator 130 may be configured to obtain measurements for metrics associated with security issues. In aspects, security management metrics may be metrics that may indicate the extent to which information, systems, assets, infrastructure, etc. in enterprise system 190 are protected while operations and functionality are delivered to customers. In aspects, security management metrics may include a count of security incidents by product, application and/or service provided by a service provider.

In aspects, in the area of customer experience, metrics calculator 130 may be configured to obtain measurements for metrics associated with how an event impacts customer experience. In aspects, customer experience metrics may be metrics that may indicate a system's ability to maintain or improve other performance indicators. In aspects, an impact to another area may indicate an impact on a customer experience. In aspects, customer experience metrics may include a number of cases or events, a number of customer calls associated with an event, a number of impacted users, a duration of events (e.g., duration of major incidents), etc.

In aspects, in the area of operations, metrics calculator 130 may be configured to obtain measurements for metrics associated with service availability, including metrics such as service uptime, transactions volume, etc. in aspects, these metrics may be evaluated to obtain scores that may be used to determine and track availability of a service. In aspects, availability of a service may indicate a user's ability to conduct operations that rely on functionality provided by the service. In aspects, hardware outages, database outages, significant application failures, and/or significant performance issues may all impact availability. In some embodiments, availability may be measured based on transaction volume, and may include auto-scale metrics that may be used to meet demand. In aspects, availability of a service may indicate or measure a percentage of time that the service is provided without a significant disruption to any other service or to any key service. In aspects, the availability metric may be applied against an overall operating schedule of twenty-four hours a day and 365 days per year.

In aspects, in the area of operations, metrics calculator 130 may be configured to obtain measurements for metrics associated with service reliability, including metrics such as error rates (including system errors), etc. In aspects, these metrics may be evaluated to obtain scores that may be used to determine and track the reliability of a service. In aspects, reliability of a service may refer to the extent to which user requests yield successful results. Reliability may measure or indicate the successful transactions as a percentage of the total transactions during all available periods for selected transaction types (e.g., search transaction, API transactions, etc.). Reliability may also include auto-recovery metrics that may improve results.

In aspects, in the area of operations, metrics calculator 130 may be configured to obtain measurements for metrics associated with service performance, including metrics such as average response time, etc. in aspects, these metrics may be evaluated to obtain scores that may be used to determine and track the performance of a service. In aspects, the service performance metrics of a service and/or application may include internal performance metrics and/or may include externally measured end-to-end transactions (e.g., request-response round-trip time). In aspects, the average response time for an application may be measured as an average of daily end-to-end median or mean response times of application transactions. In particular embodiments, internal performance metric measurements may include all transactions for selected transaction types, and may include a measurement of device time to reach local applications and/or services of enterprise system 190. Externally measured end-to-end transactions may be specific sample transactions (e.g., a static profile) that may be repeated consistently from various geographic locations.

In aspects, in the area of operations, metrics calculator 130 may be configured to obtain measurements for metrics associated with incident management. In aspects, incident management metrics, as used herein, may refer to metrics that may indicate performance of a service based on management of events that impact user experience. For example, incident management metrics may include total counts (e.g., number of events), and mean-time metrics by individual cases based on priority, severity, impact level (e.g., events impacting more than a threshold percentage of users or unique users), event duration (e.g., the difference between the start time and the end time of an event), number of received user calls associated with an event (e.g., a major event), etc.

It is noted that the discussion above describing the various metrics that may be measured to determine a quality of a service is not intended to be limiting in any way. As such, it is noted that the above described metrics are not the only metrics that may be measured to determine service quality in accordance with the present disclosure, and that other metrics may additionally or alternatively be used.

Score manager 140 may be configured to apply the obtained measurements for the various metrics associated with the various services to scoring models to obtain respective service scores for the various services. For example, measurements may be obtained for one or more of the metrics described herein for a first service. The measurements obtained may be applied to scoring models to determine service scores for the first service. In aspects, the service scores obtained may be time-based. For example, a service score may represent the service score of the first service for a particular time period (e.g., monthly, quarterly, yearly, etc.). In some aspects, the service score may be a score for a single event, or may be an aggregated score that includes scores for multiple events over a time period. In these aspects, the service score over the period of time may represent the aggregated score of the multiple events. In still some aspects, a service score of a service may be associated with a particular area (e.g., development, operations, financial, security, customer experience, etc.). In these aspects, the service score for the various areas may be aggregated to obtain an overall service score for the service.

Output generator 150 may be configured to generate service performance reports. In aspects, a service performance report may include a visual representation of the service scores for a service or services from service provider(s), data visualization for the various metric measurements obtained by system 100, and/or a representation of performance trends. In aspects, the service performance reports may include different reports based on an organizational level. For example, in aspects, service performance reports may be generated at the enterprise level, at the business segment level, and/or at the service level. In aspects, the structure of the different level reports may be defined by a predefined template (e.g., a template stored in database 120).

Having described the functionality of the various components of system 100, a description of an operational example of system 100 for evaluating and scoring services provided to a system from service providers in accordance with embodiments of the present disclosure now follows. It will be appreciated that the description of the following operational example of system 100 is intended as a non-limiting example for illustrative purposes. As such, operations of system 100 may include other functionality as described herein.

During operation of system 100, information related to events associated with one or more services deployed within enterprise system 190 may be received or obtained. In aspects, the information related to the events may include information associated with various metrics (e.g., metrics described herein). For example, in aspects, information related to cases or events may include various times associated with the events (e.g., date/time that an event associated with a service occurred, date/time that the event was logged to a case management system, date/time that the event logging is acknowledged by service provider, date/time that the event is mitigated or restored, date/time that the service is back to full operating state, etc.), severity of the cases or events, priority of the cases or events, identifying information for the event or case (e.g., service provider, affected application, etc.), service dependencies, etc.

In aspects, during operation of system 100, measurements associated with one or more metrics may be obtained for the one or more services based on the information related to the events. For example, measurements may be obtained for one or more of the various metrics described above. In one particular example, measurements may be obtained associated with incident management metrics. In aspects, incident management metrics may include total counts (e.g., number of events), mean-time metrics by individual cases based on priority, severity, impact level (e.g., events impacting more than a threshold percentage of users or unique users), event duration (e.g., the difference between the start time and the end time of an event), number of received user calls associated with an event (e.g., a major event), customer experience scores, etc. The measurements obtained may be used to determine one or more service scores for the one or more services. The one or more scores may then be used to obtain an overall service score.

For example, in aspects, mean-time metrics may be measured to obtain one or more mean-time scores for the one or more services based on multiple events over a defined period of time. In aspects, mean-time metrics may include one or more of a mean-time to open (e.g., average time between the occurrence of an event associated with a service and the time when the event is logged in a case management system for the service provider), a mean-time to acknowledge (e.g., average time between the time when the event is logged in the case management system and the time when the service provider acknowledges the event being logged), a mean-time to mitigate (e.g., average time between the occurrence of the event and the time when the service provider implements mitigation operations to mitigate the impact of the event on the enterprise system (e.g., to mitigate the impact on customer experience)), and/or a mean-time to resolve (e.g., average time between the occurrence of the event and the time when the service provider fully addresses the event and returns the service to full normal operational state). In some embodiments, a mean-time to detect (e.g., average time between the occurrence of an event associated with a service and the time when the event is detected by the service provider) may be obtained in the case of major incidents that impact a large amount of customers. In this case, the impact is substantial.

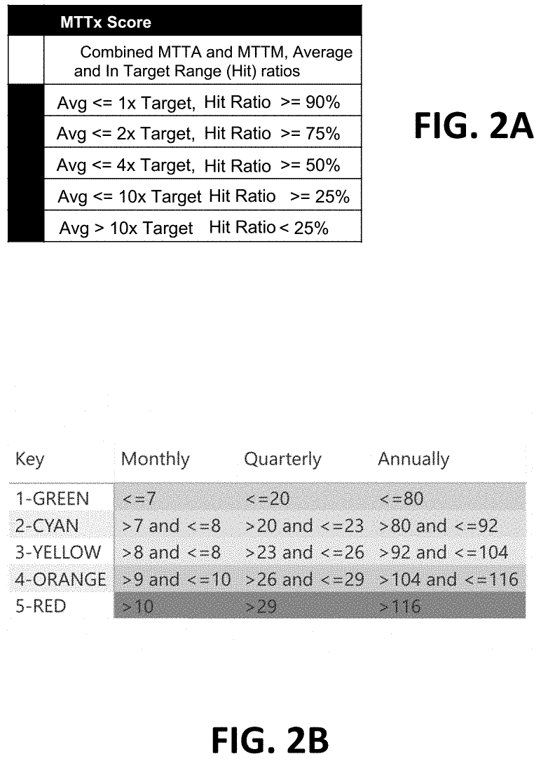

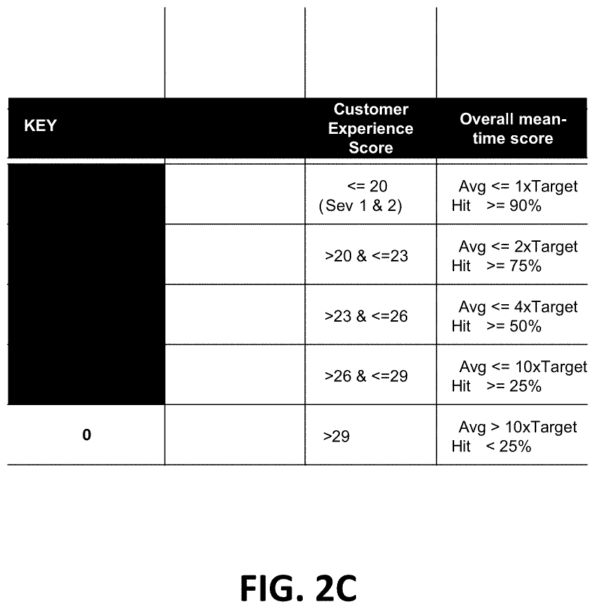

In aspects, a mean-time score may represent a key performance indicator for day-to-day performance of a service. FIG. 2A is a diagram illustrating an example of a mean-time score matrix in accordance with aspects of the present disclosure. A mean-time score for a service based on multiple events over a defined period of time may represent a combination of a hit ratio and an x-factor ratio. In aspects, a hit ratio may indicate a percentage of the multiple events within the defined time period that fall within a target range. The target range may be defined in minutes, and may represent the target range for performing a corresponding activity for the event. For example, a target range for a mean-time to open score may include a target range (e.g., in minutes) within which the event should be open. The mean-time to open score may depend on the percentage of the multiple events within the defined time period that are opened within the target range. Similarly, in another example, a target range for a mean-time to resolve score may include a target range (e.g., in minutes) within which the event should be resolved. The mean-time to resolve score may depend on the percentage of the multiple events within the defined time period that are resolved within the target range to resolve. In aspects, an x-factor ratio may indicate a ratio of the average response time and the target range. For example, a ratio of the average response time of the multiple events within the defined time period to the target range may be obtained, and the mean-time score may be obtained based on the ratio.

For example, as shown in FIG. 2A, a hit ratio of greater than or equal to 90% (e.g., indicating that at least 90% of the multiple events within the defined time period that fall within the target range) and an x-factor ratio of less than or equal to 1× (e.g., indicating that the ratio between the average response time of the multiple events within the defined time period to the target range is no greater than one to one) may result in a mean-time score of 4. In the example illustrated in FIG. 2A, a hit ratio of greater than or equal to 75% (e.g., indicating that at least 75% of the multiple events within the defined time period that fall within the target range) and an x-factor ratio of less than or equal to 2× (e.g., indicating that the ratio between the average response time of the multiple events within the defined time period to the target range is no greater than two to one) may result in a mean-time score of 3. On the other hand, a hit ratio of greater than or equal to 50% (e.g., indicating that at least 50% of the multiple events within the defined time period that fall within the target range) and an x-factor ratio of less than or equal to 4× (e.g., indicating that the ratio between the average response time of the multiple events within the defined time period to the target range is no greater than four to one) may result in a mean-time score of 2. On the other hand, a hit ratio of greater than or equal to 25% (e.g., indicating that at least 25% of the multiple events within the defined time period that fall within the target range) and an x-factor ratio of less than or equal to 10× (e.g., indicating that the ratio between the average response time of the multiple events within the defined time period to the target range is no greater than ten to one) may result in a mean-time score of 1, and a hit ratio of less than 25% (e.g., indicating that less than 25% of the multiple events within the defined time period that fall within the target range) and an x-factor ratio of greater than 10× (e.g., indicating that the ratio between the average response time of the multiple events within the defined time period to the target range is greater than ten to one) may result in a mean-time score of 0. In aspects, the different mean-time scores may be assigned a different color. It should be appreciated that the description of five mean-time scores discussed above is merely for illustrative purposes only, and more or less scores may be used. For example, in some embodiments, additional scores may be used with narrower percentages ranges, in some cases some of the percentage ranges may be collapsed to include less mean-time scores.

In aspects, the overall mean-time score over a defined time period for a service may include a combination (e.g., an average) of the mean-time scores for different types of mean-time scores for the defined time period. For example, an overall mean-time score for a service over a defined time period may include any combination of a mean-time to open score for the multiple events over the defined time period, a mean-time to detect score for the multiple events over the defined time period, a mean-time to acknowledge score for the multiple events over the defined time period, a mean-time to mitigate score for the multiple events over the defined time period, and/or a mean-time to resolve score for the multiple events over the defined time period.

In some aspects, respective mean-time scores may be obtained for different priority levels of the different events. For example, a respective mean-time to open score may be obtained for different priority levels of the multiple events within the defined time period. Similarly, a respective mean-time to detect score, a respective mean-time to acknowledge score, a respective mean-time to mitigate score, and/or a respective mean-time to resolve score may be obtained for different priority levels of the multiple events within the defined time period. In aspects, the different priority levels may include five priority levels ranging from priority level 5 for low priority events (e.g., events that impact a low threshold number of customers, such as events that affect one customer or less than a priority level 5 threshold number of customers) to priority level 1 for highest priority events (e.g., major events that affect a large and substantial number of customers or higher than a priority level 1 threshold number of customers). In aspects, as noted above, any of the individual mean-time scores may be combined to obtain an overall mean-time score associated with each of the different priority level of events.

In aspects, determining the one or more service scores for the one or more services may include determining at least one customer experience score. A customer experience score may represent a key performance indicator for major impacting events. FIG. 2B is a diagram illustrating an example of a customer experience score matrix in accordance with aspects of the present disclosure. A customer experience score for a service based on multiple events over a defined period of time may represent a score for major events. A major event may include events that affect or impact a large number of customers (e.g., internal customers and/or external customers). In aspects, the large number of customers may be a number of customers exceeding a major event threshold. In aspects, there may be more than one category of major events. For example, in aspects, major events may be sub-categorized by event severity. The severity of an event may be based on the number of customers impacted by the event. For example, a severity one event may be one that impacts a number of customers exceeding a first severity threshold, and a severity two event may be one that impacts a number of customers exceeding a second severity threshold but not exceeding the first severity threshold. In aspects, a customer experience score may be calculated based on the number of major events over the defined period of time. For example, as shown in FIG. 2B, a customer experience score of 1 may be assigned in one or more scenarios. For example, a customer experience score of 1 may be assigned to a service when the service is associated with a number of major events that is less than or equal to seven within a month, with a number of major events that is less than or equal to twenty within a quarter, or with a number of major events that is less than or equal to eighty within a year. In the same example, a customer experience score of 2 may be assigned to a service when the service is associated with a number of major events that is more than seven and less than or equal to eight within a month, with a number of major events that is more than twenty and less than or equal to twenty-three within a quarter, or with a number of major events that is greater than eighty and less than or equal to ninety-two within a year. Still in the same example, a customer experience score of 3 may be assigned to a service when the service is associated with a number of major events that is more than eight and less than or equal to nine within a month, with a number of major events that is more than twenty-three and less than or equal to twenty-six within a quarter, or with a number of major events that is greater than ninety-two and less than or equal to one hundred and four within a year. Still in the same example, a customer experience score of 4 may be assigned to a service when the service is associated with a number of major events that is more than nine and less than or equal to ten within a month, with a number of major events that is more than twenty-six and less than or equal to twenty-nine within a quarter, or with a number of major events that is greater than one hundred and four and less than or equal to one hundred and sixteen within a year. Still in the same example, a customer experience score of 5 may be assigned to a service when the service is associated with a number of major events that is greater than ten within a month, with a number of major events that is greater than twenty-nine within a quarter, or with a number of major events that is greater than one hundred and sixteen within a year. In aspects, the different customer experience scores may be assigned a different color. It should be appreciated that the description of five customer experience scores discussed above is merely for illustrative purposes only, and more or less scores may be used. For example, in some embodiments, additional customer experience scores may be used with narrower ranges, in some cases some of the ranges may be collapsed to include less customer experience scores.

During operation of system 100, an overall service score may be determined for the one or more services for the defined period of time. In some aspects, the overall service score may be determined based on a combination of the overall mean-time score (e.g., any combination of the various mean-time scores) for the multiple events over the defined period of time and the customer experience score of the service for the defined period of time. For example, in some aspects, the overall service score may be obtained by averaging the overall mean-time score and the customer experience score. In this example, the overall mean-time score may be added to the customer experience score of the service for the defined period of time and divided by two to obtain the overall service score for the service for the defined period of time.

In alternative or additional aspects, the overall service score may be obtained based on a score matrix. FIG. 2C is a diagram illustrating an example of an overall service score matrix in accordance with aspects of the present disclosure. As shown in FIG. 2C, an overall service score may be obtained based on the combination of the different ranges of the overall mean-time score and different ranges of the customer experience score. For example, an overall service score of 2 may be obtained when the overall mean-time includes a hit ratio greater than or equal to 50% and an x-factor ratio of 4×, and the customer experience score is greater than twenty-three and less than or equal to twenty-six.

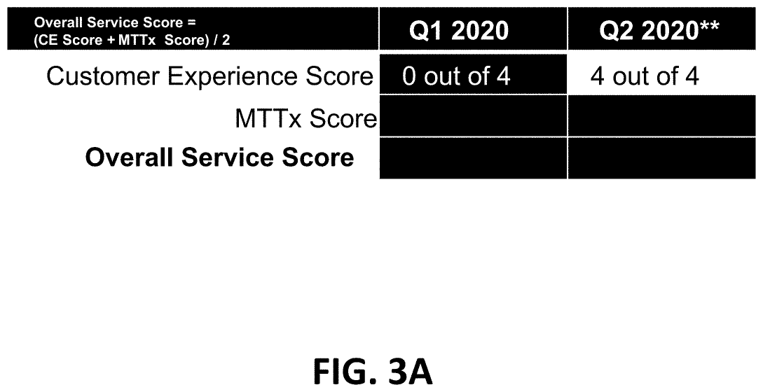

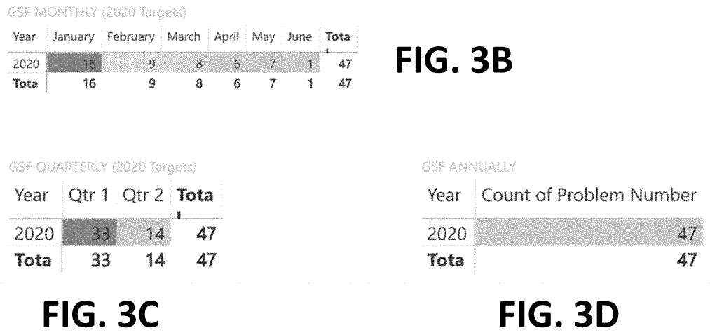

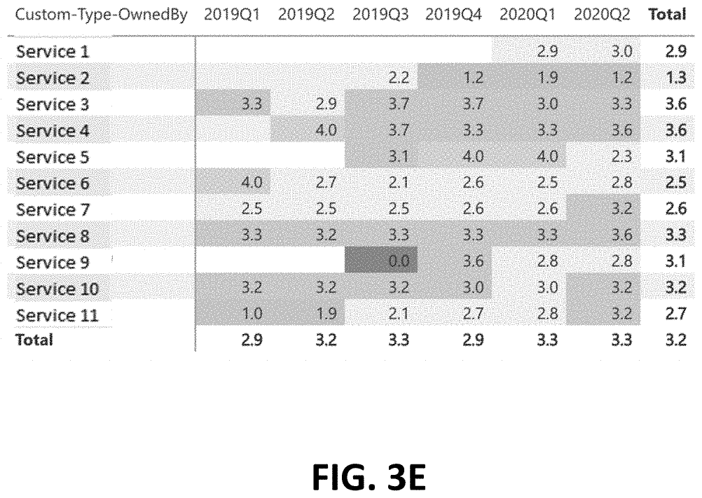

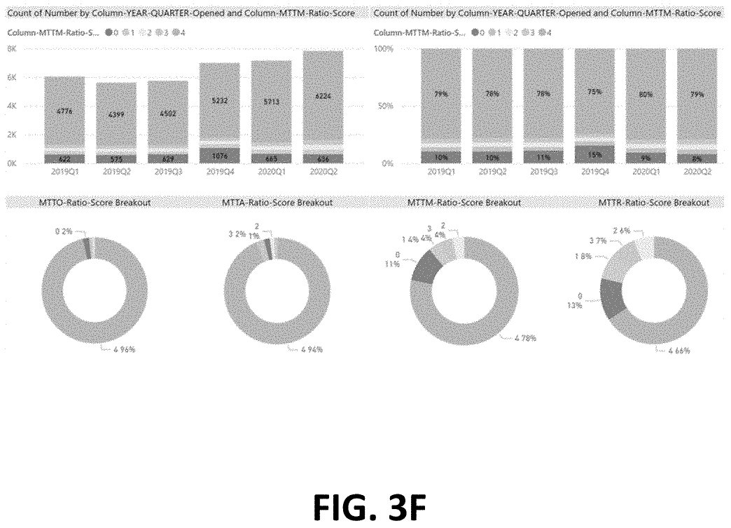

In aspects, during operation of system 100, one or more performance reports may be generated and presented to a user. FIGS. 3A-3F show multiple examples of various performance reports that may be generated based on the service performance scores and/or measurements obtained with respect to various services. For example, FIG. 3A is a diagram illustrating an example of a performance report for a specific service including reports of overall service scores based on a combination of an overall mean-time score and a customer experience score for defined periods of time (e.g., quarterly in the examples illustrated). FIGS. 3B-3D are diagrams illustrating examples of a performance report including customer experience scores based on different defined time periods. For example, FIG. 3B shows an example of a customer experience scores report, in the form of color coded scores, for various months and includes a number of major events for each month. FIG. 3C shows an example customer experience scores, in the form of color coded scores, for various quarters and includes a number of major events for each quarter. FIG. 3D shows an example customer experience scores report, in the form of color coded scores, for a year and includes a number of major events for the year.

FIGS. 3E-3F are diagrams illustrating examples of a performance report including mean-time scores for different defined time periods. For example, FIG. 3E shows an example mean-time scores report, in the form of color coded scores, for multiple services deployed within enterprise system 190. As shown, mean-time scores are provided for various quarters. Total mean-time scores may be provided for each service over the various quarters, and/or total mean-time scores may be provided for each quarter over the various services. FIG. 3F shows a diagram illustrating another example of a mean-time scores report for a service over multiple defined periods of time. As shown, the various types of mean-time scores may be plotted as absolute counts or percentages, and a breakout diagram may be provided for the various types of mean-time scores.

It should be noted that a score for a service may represent performance of the service. However, the performance of a service may be dependent, or affected, by the performance of inter-related services. For example, when information related to an inter-related service is excluded, the performance measurement of a service may increase, as the inter-related service may be causing the performance measurement of the service to be lower. Similarly, in some aspects, the performance reports for a service may be filtered based on different characteristics. For example, in some aspects, the information related to a service from which the metric measurements are obtained may be filtered by type. In aspects, for example, a score (e.g., a mean-time score or a customer experience score) may be based on information that focuses on incidents or events that have been closed (e.g., resolved or unresolved) and for which the impact is on external and/or internal customers. In this manner, a performance report may be focused on customer and employee performance.

In aspects, the various service providers may be provided access to the various functionality of system 100 to assess services and generate service performance reports. In some aspects, access to the various functionality of system 100 may be specified by user role to provide secure access and to protect information. For example, a service provider may be allowed to access information on performance and quality assessments of services associated with the service provider, but the service provider may be prevented from accessing information related to services associated with other service providers.

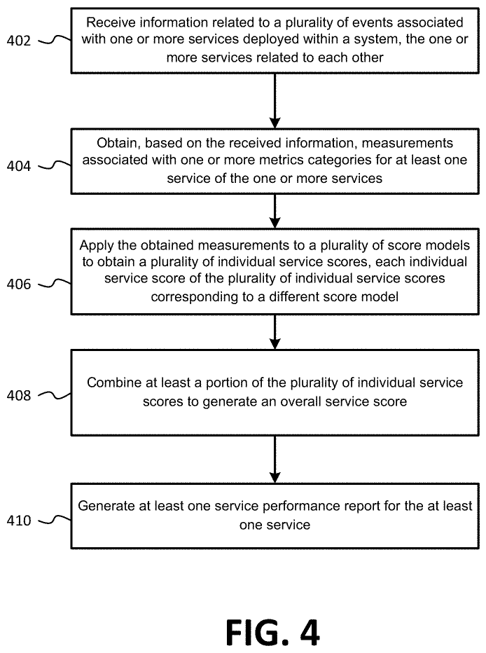

FIG. 4 shows a functional block diagram illustrating an example flow executed to implement aspects of the present disclosure.

FIG. 4 shows a high level flow diagram of operation of a system configured in accordance with aspects of the present disclosure for providing mechanisms for evaluating and scoring services provided to a system from service providers to improve the services across the system in accordance with embodiments of the present disclosure. For example, the functions illustrated in the example blocks shown in FIG. 4 may be performed by system 100 of FIG. 1 according to embodiments herein.

At block 402, information related to a plurality of events associated with one or more services deployed within a system may be received. In aspects, the one or more services may be related to each other. At block 404, the system obtains, based on the received information, measurements associated with one or more metrics categories for at least one service of the one or more services. In aspects, the metrics categories may include any one of a number of metric categories as discussed above with respect to FIG. 1.

At block 406, the obtained measurements are applied to a plurality of score models to obtain a plurality of individual service scores. In aspects, each individual service score of the plurality of individual service scores may correspond to a different score model of the plurality of score models. In aspects, applying the obtained measurements to the plurality of score models to obtain the plurality of individual service scores may include comparing a measurement of the obtained measurements against a target performance, and determining an individual service score associated with the measurement based on the comparing. In aspects, the individual service score may be based on a range within which the measurement falls with respect to the target performance. For example, a measurement falling within a first range with respect to the target performance may be assigned a first individual score, and a measurement falling within a second range different from the first range with respect to the target performance may be assigned a second individual score. In aspects, the individual service score for a measurement may be obtained from a score matrix that associates service scores to the range within which the measurement falls with respect to the target performance.

In aspects, the plurality of score models may include one or more mean-time score models configured to obtain at least one mean-time score associated with the plurality of events over a defined period of time. The at least one mean-time score may include one or more of: a mean-time to open score, a mean-time to detect score, a mean-time to acknowledge score, a mean-time to mitigate score, or a mean-time to resolve score. In aspects, the plurality of score models may include a customer experience score model to obtain a customer experience score associated with the plurality of events over the defined period of time. In aspects, the defined period of time is one of a month, a quarter, or a year.

At block 408, at least a portion of the plurality of individual service scores are combined to generate an overall service score. For example, a first individual score and a second individual score of the plurality of individual scores may be combined (e.g., by average) to obtain the overall service score. At block 410, at least one service performance report is generated for the at least one service. In aspects, the at least one service performance report may include a report that includes the overall service score, a report that includes one or more individual service score of the plurality of individual service scores, and/or a report that includes at least one of the obtained measurements. In aspects, generating the report that includes one or more individual service score of the plurality of individual service scores may include presenting the one or more individual service score color coded based on a value of the one or more individual service score.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods and steps described in the specification.

What is claimed is:

1. A method of evaluating performance of a service, comprising:
receiving information related to a plurality of events associated with one or more services deployed within a system, the one or more services related to each other;
obtaining, based on the received information, measurements associated with one or more metrics categories for at least one service of the one or more services;
applying the obtained measurements to a plurality of score models to obtain a plurality of individual service scores, each individual service score of the plurality of individual service scores corresponding to a different score model;
combining at least a portion of the plurality of individual service scores to generate an overall service score; and
generating at least one service performance report for the at least one service.

2. The method of claim 1, wherein applying the obtained measurements to the plurality of score models to obtain the plurality of individual service scores includes:
comparing a measurement of the obtained measurements against a target performance; and
determining an individual service score associated with the measurement based on the comparing, wherein the individual service score is based on a range within which the measurement falls with respect to the target performance.

3. The method of claim 2, wherein the individual service score is obtained from a score matrix that associates service scores to the range within which the measurement falls with respect to the target performance.

4. The method of claim 1, wherein the plurality of events includes one or more of an outage, an incident, a problem, a configuration change, or an event impacting at least a portion of functionality of the system.

5. The method of claim 1, wherein generating the at least one service performance report for the at least one service includes one or more of:
generating a report that includes the overall service score;
generating a report that includes one or more individual service score of the plurality of individual service scores; or
generating a report that includes at least one of the obtained measurements.

6. The method of claim 5, wherein generating the report that includes one or more individual service score of the plurality of individual service scores includes presenting the one or more individual service score color coded based on a value of the one or more individual service score.

7. The method of claim 1, wherein the plurality of score models includes one or more of:
one or more mean-time score models configured to obtain at least one mean-time score associated with the plurality of events over a defined period of time; and
a customer experience score model to obtain a customer experience score associated with the plurality of events over the defined period of time.

8. The method of claim 7, wherein the at least one mean-time score includes one or more of: a mean-time to open score, a mean-time to detect score, a mean-time to acknowledge score, a mean-time to mitigate score, or a mean-time to resolve score.

9. The method of claim 7, wherein the defined period of time is one of a month, a quarter, or a year.

10. A system for evaluating performance of a service, comprising:
an enterprise system including one or more services deployed therein, the one or more services related to each other; and
a server configured to perform operations including:
receiving information related to a plurality of events associated with the one or more services;
obtaining, based on the received information, measurements associated with one or more metrics categories for at least one service of the one or more services;
applying the obtained measurements to a plurality of score models to obtain a plurality of individual service scores, each individual service score of the plurality of individual service scores corresponding to a different score model;
combining at least a portion of the plurality of individual service scores to generate an overall service score; and
generating at least one service performance report for the at least one service.

11. The system of claim 10, wherein applying the obtained measurements to the plurality of score models to obtain the plurality of individual service scores includes:
comparing a measurement of the obtained measurements against a target performance;
determining an individual service score associated with the measurement based on the comparing, wherein the individual service score is based on a range within which the measurement falls with respect to the target performance.

12. The system of claim 11, wherein the individual service score is obtained from a score matrix that associates service scores to the range within which the measurement falls with respect to the target performance.

13. The system of claim 10, wherein the plurality of events includes one or more of an outage, an incident, a problem, a configuration change, or an event impacting at least a portion of functionality of the system.

14. The system of claim 10, wherein generating the at least one service performance report for the at least one service includes one or more of:
generating a report that includes the overall service score;
generating a report that includes one or more individual service score of the plurality of individual service scores; or
generating a report that includes at least one of the obtained measurements.

15. The system of claim 14, wherein generating the report that includes one or more individual service score of the plurality of individual service scores includes presenting the one or more individual service score color coded based on a value of the one or more individual service score.

16. The system of claim 10, wherein the plurality of score models includes one or more of:
one or more mean-time score models configured to obtain at least one mean-time score associated with the plurality of events over a defined period of time; and
a customer experience score model to obtain a customer experience score associated with the plurality of events over the defined period of time.

17. The system of claim 16, wherein the at least one time score includes one or more of: a mean-time to open score, a mean-time to detect score, a mean-time to acknowledge score, a mean-time to mitigate score, or a mean-time to resolve score.

18. The system of claim 16, wherein the defined period of time is one of a month, a quarter, or a year.

19. A computer-based tool for evaluating performance of a service, the computer-based tool including non-transitory computer readable media having stored thereon computer code which, when executed by a processor, causes a computing device to perform operations comprising:
receiving information related to a plurality of events associated with one or more services deployed within a system, the one or more services related to each other;
obtaining, based on the received information, measurements associated with one or more metrics categories for at least one service of the one or more services;
applying the obtained measurements to a plurality of score models to obtain a plurality of individual service scores, each individual service score of the plurality of individual service scores corresponding to a different score model;
combining at least a portion of the plurality of individual service scores to generate an overall service score; and
generating at least one service performance report for the at least one service.

20. The computer-based tool of claim 19, wherein the plurality of score models includes one or more of:
one or more mean-time score models configured to obtain at least one mean-time score associated with the plurality of events over a defined period of time; and
a customer experience score model to obtain a customer experience score associated with the plurality of events over the defined period of time.
